(19) United States
(12) Patent Application Publication
(10) Pub. No.: US 2011/0197484 A1
(43) Pub. Date: Aug. 18, 2011

(54) Security label

(76) Inventors: Yang-Huang Lin, Pingtung (TW); Rong-Jie Shen, Guangdong (CN)

(21) Appl. No.: 13/063,758

(22) PCT Filed: Jul. 8, 2009
(86) PCT No.: PCT/CN2009/072690

§ 371 Date: Mar. 14, 2011

(30) Foreign Application Priority Data
Sep. 22, 2008 (CN) 200810198654.4

(51) Int. Cl. G09F 3/03

(52) U.S. Cl. 40/675

(57) ABSTRACT

A security label includes a substrate; and a film formed on the substrate and comprising at least one anti-counterfeiting pattern each including a plurality of parallel anti-counterfeiting lines each having a plurality of anti-counterfeiting units. It is easy for consumers to identify the genuine products by viewing the security label placed on the product in a predetermined angle range. The film may be formed on the substrate which may be made of one of a wide variety of materials. No ink, dye, and organic solution are employed in the manufacturing process. The manufacturing cost is decreased greatly. More than one anti-counterfeiting pattern may be formed on the substrate without causing interference. Hence, its anti-counterfeiting effects are excellent. Counterfeiting of the security label is very difficult.

### BACKGROUND OF THE INVENTION

1. Field of Invention

The invention relates to security labels and more particularly to a security label with improved anti-counterfeiting characteristics.

2. Description of Related Art

Label counterfeiting is becoming an increasingly frequent and dangerous problem. In one form of counterfeiting, the labels are removed from discarded authentic containers; and then the labels are reapplied to non-authentic containers containing a replica or other fake of the original product. To address this counterfeiting problem, conventional labels by employing the technology of bar codes, laser, etc. have been developed. However, those labels address the counterfeiting issue may be cost prohibitively high. For those low price labels, they are susceptible to counterfeit or create manufacturing difficulties. Thus, the need for improvement still exists.

### SUMMARY OF THE INVENTION

It is therefore one object of the invention to provide a cost effective and temper-evident security label.

To achieve the above and other objects, the invention provides a security label comprising a substrate and a film.

The substrate is formed on bottom of the film as base. The film comprises at least one anti-counterfeiting pattern each including a plurality of parallel first anti-counterfeiting lines each having a plurality of gable first anti-counterfeiting units arranged as a straight line. The at least one anti-counterfeiting pattern comprises first and second anti-counterfeiting patterns in which anti-counterfeiting units of the first anti-counterfeiting pattern are at angle of greater than 0-degree to less than 180-degree with respect to the anti-counterfeiting units of the second anti-counterfeiting pattern. Distance between any two adjacent anti-counterfeiting units of the first anti-counterfeiting pattern (or the second anti-counterfeiting pattern) is equal to zero or greater than zero. It means that the anti-counterfeiting units of the first anti-counterfeiting pattern (or the second anti-counterfeiting pattern) can be overlapped but not intersected. The first anti-counterfeiting pattern and the second anti-counterfeiting pattern are partially overlapped.

There are further provided a plurality of anti-copy patterns on the film. The anti-copy patterns are formed on the top surface of the substrate not occupied by the film. The anti-copy pattern is gable and comprises at least one anti-copy section each including a plurality of equally spaced anti-copy units. The anti-copy units are gable.

The anti-copy units are at angle of greater than 0-degree to less than 180-degree with respect to the anti-counterfeiting units of the first anti-counterfeiting pattern. Diameter of each anti-counterfeiting unit (or anti-copy unit) is between about 0.001 to 0.1 mm. Preferably, the diameter of each anti-counterfeiting unit (or anti-copy unit) is between about 0.005 to 0.090 mm. More advanced manufacturing equipment is required if the diameter of each anti-counterfeiting unit is less than about 0.001 mm. Distance between any two adjacent anti-counterfeiting lines of the same anti-counterfeiting pattern is about 1 to 5 times of the diameter of the anti-counterfeiting unit. Distance between any two adjacent anti-counterfeiting units of the same anti-counterfeiting pattern is about 1 to 5 times of the diameter of the anti-counterfeiting unit.

The anti-counterfeiting units and the anti-copy units are fixedly formed on the substrate by printing ink thereon or integrally formed on the substrate by laser engraving thereon. The substrate can be a material selected from metal, paper, plastic, wood, glass, and leather. The manufacturing process may be pressing, printing, ironing, engraving, injection molding, casting, punching, forging, CNC engraving, and laser engraving. Moreover, modification of the conventional label manufacturing technique is not required. The manufacturing cost increase is minimized without lowering the yield.

The invention incorporating the anti-counterfeiting patterns and the anti-copy patterns can render a security label to be temper-evident.

The above and other objects, features and advantages of the invention will become apparent from the following detailed description taken with the accompanying drawings.

### BRIEF DESCRIPTION OF THE DRAWINGS

FIG. 1 is a longitudinal sectional view of a security label according to a first preferred embodiment of the invention;

FIG. 2 is a top view of a portion of the film;

FIG. 3 is a detailed view of the area A in FIG. 2;

FIG. 4 is a top view of the letter “A” in FIG. 2;

FIG. 5 is a detailed view of the area B in FIG. 4;

FIG. 6 is a top view of the letter “B” in FIG. 2;

FIG. 7 is a detailed view of the area C in FIG. 6;

FIG. 8 schematically depicts reflection of light when lines on the surface are less dense;

FIG. 9 schematically depicts reflection of light when lines on the surface are more dense; and

FIG. 10 schematically depicts the overlapping area of the first and second anti-counterfeiting patterns according to a second preferred embodiment of the invention.

### DETAILED DESCRIPTION OF THE INVENTION

### First Preferred Embodiment

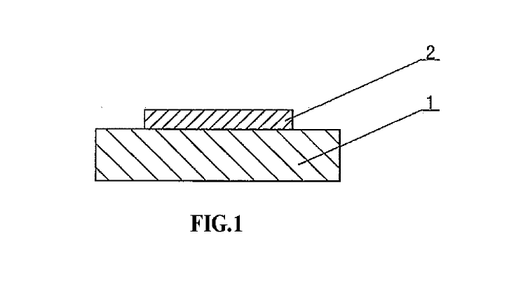

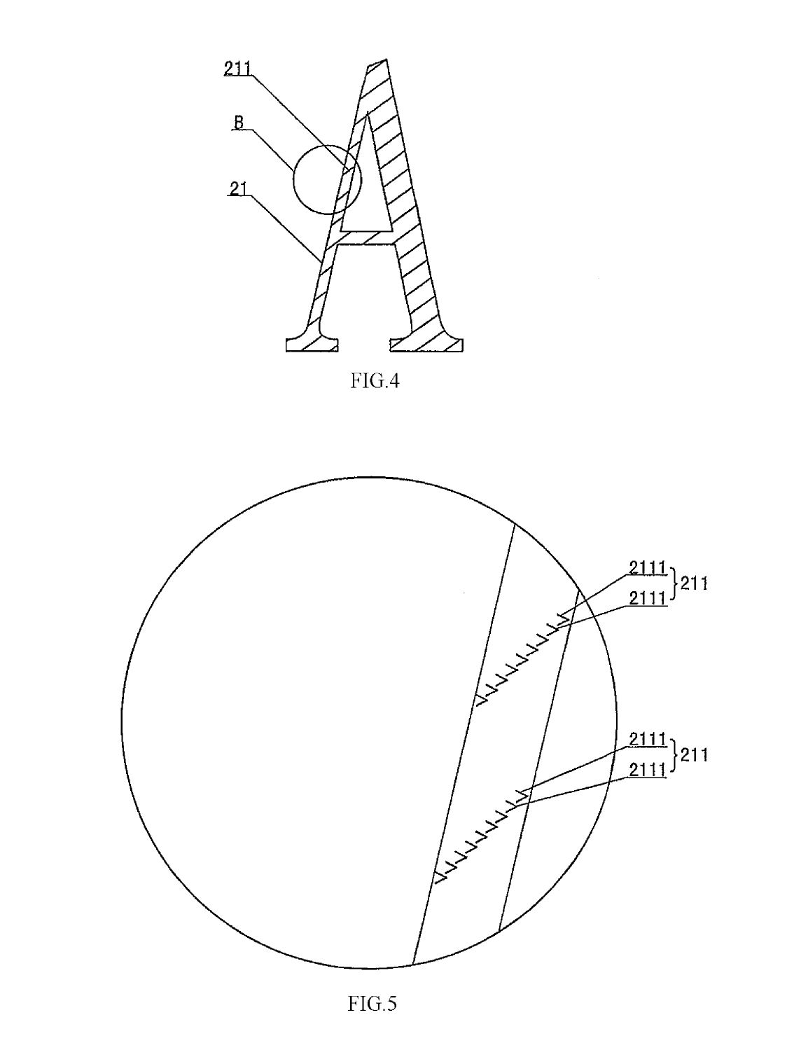

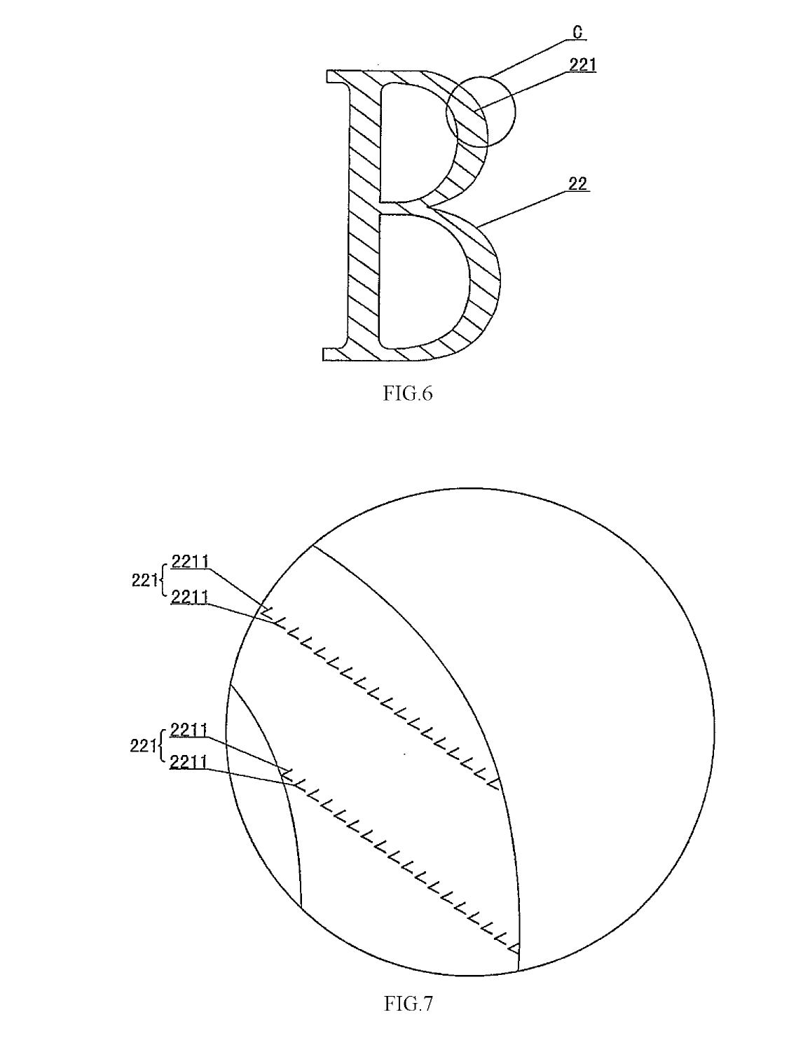

Referring to FIGS. 1 to 9, a security label in accordance with a first preferred embodiment of the invention is shown.

As shown, the security label comprises a substrate 1 and a film 2.

The substrate 1 is formed on bottom of the film 2 as base. The film 2 comprises a first anti-counterfeiting pattern 21 (i.e., letter “A”) and a second anti-counterfeiting pattern 22 (i.e., letter “B).

The first anti-counterfeiting pattern 21 comprises a plurality of parallel first anti-counterfeiting lines 211 each including a plurality of gable first anti-counterfeiting units 2111 arranged as a straight line. The first anti-counterfeiting pattern 22 comprises a plurality of parallel second anti-counterfeiting lines 221 each including a plurality of gable second anti-counterfeiting units 2211 arranged as a straight line. T he first anti-counterfeiting units 2111 are at angle of greater than 0-degree to less than 180-degree with respect to the second anti-counterfeiting units 2211.

The first and second anti-counterfeiting lines 211, 221 can be straight (as in this embodiment) or curved in other embodiments. Straight lines are preferred due to simplicity and improved characteristics.

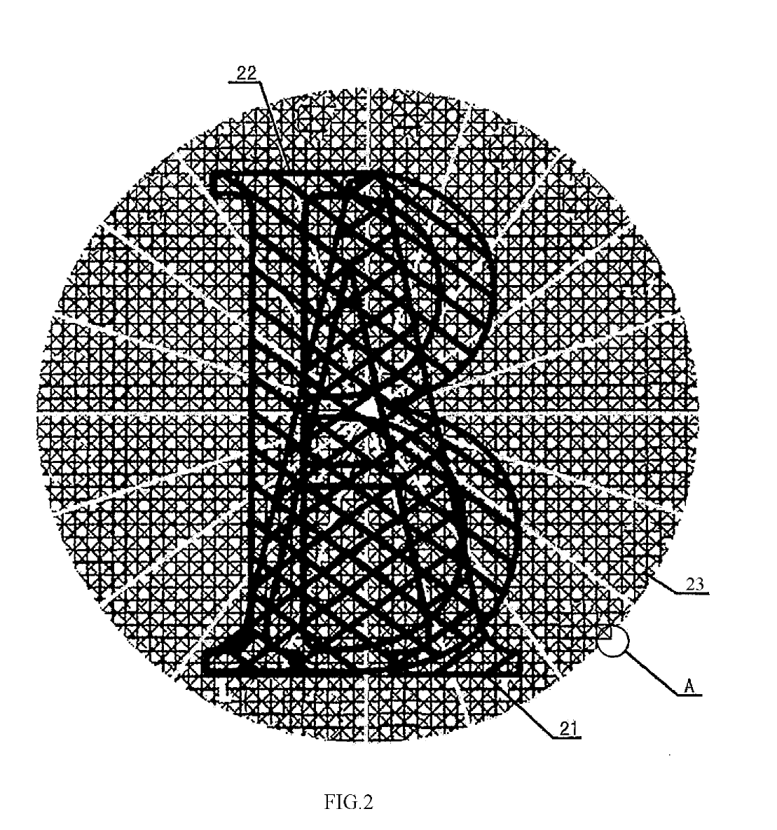

The number of each of the first and second anti-counterfeiting units 2111, 2211 is greater than 2. Light impinges on an inner surface of one section of each of the first and second anti-counterfeiting units 2111, 2211 may reflect to an inner surface of the other section thereof. Next, the light may reflect outward. A person may see the light if the eyes are in the path of the specular reflection. The shapes of the first anti-counterfeiting units 2111 and second anti-counterfeiting units 2211 are gable because it can increase the specular reflection. Distance between any two adjacent ones of the first anti-counterfeiting units 2111 (or the second anti-counterfeiting units 2211) is equal to zero or greater than zero. It means that the first anti-counterfeiting units 2111 (or the second anti-counterfeiting units 2211) can be overlapped but not intersected. Thus, it is possible of forming at least two patterns. As shown in FIG. 2, the first anti-counterfeiting pattern 211 and the second anti-counterfeiting pattern 221 are partially overlapped. Distance between any two adjacent ones of the first anti-counterfeiting units 2111 (or the second anti-counterfeiting units 2211) is greater than zero.

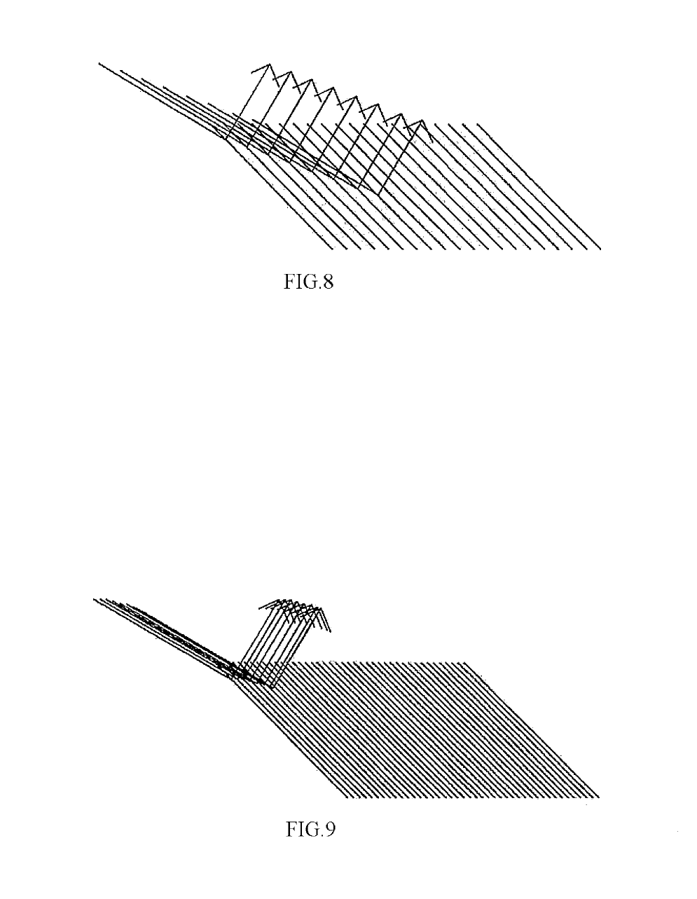

Further, distance between any two adjacent ones of the first anti-counterfeiting lines 211 (or the second anti-counterfeiting lines 221) is the same. This ensures that images reflected from the first anti-counterfeiting lines 211 (or the second anti-counterfeiting lines 221) are the same as viewed by the eyes. As shown in FIGS. 8 and 9, the greater of the distance between the first anti-counterfeiting lines 211 (or the second anti-counterfeiting lines 221) the weaker of the reflection will be and vice versa.

For preventing any unauthorized persons from copying the anti-counterfeiting patterns by scanner, a plurality of anti-copy patterns 23 are included in the film 2. The anti-copy patterns 23 are formed on the top surface of the substrate 1 not occupied by the film 2.

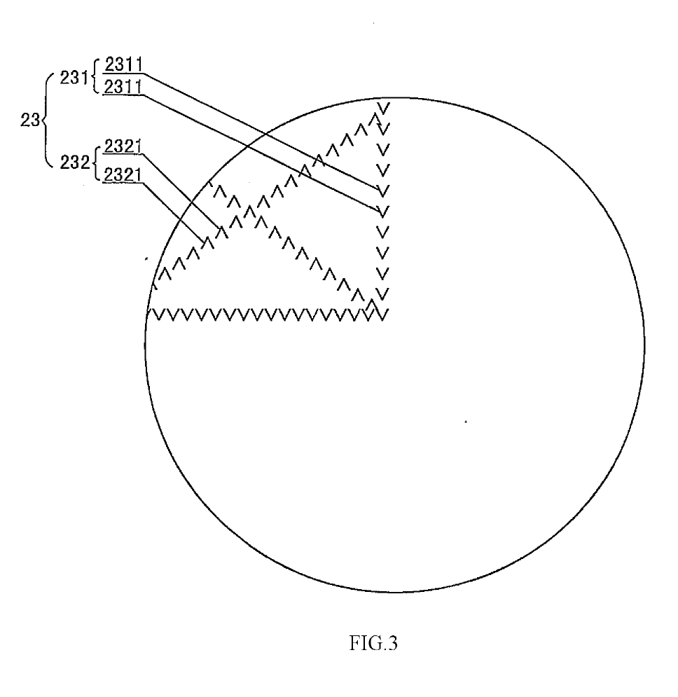

As shown in FIG. 3, the anti-copy pattern 23 is gable and comprises a first anti-copy section 231 and a second anti-copy section 232 intersecting the first anti-copy section 231. The first anti-copy section 231 comprises a plurality of equally spaced first anti-copy units 2311 and the second anti-copy section 232 comprises a plurality of equally spaced second anti-copy units 2321.

The first anti-copy units 2311 are gable. The first anti-copy units 2311 are at angle of greater than 0-degree to less than 180-degree with respect to the first anti-counterfeiting units 2111. Likewise, the second anti-copy units 2321 are gable. The second anti-copy units 2321 are at angle of greater than 0-degree to less than 180-degree with respect to the second anti-counterfeiting units 2211.

The diameter of each anti-counterfeiting unit (or anti-copy unit) is between about 0.001 to 0.1 mm. Preferably, the diameter of each anti-counterfeiting unit (or anti-copy unit) is between about 0.005 to 0.090 mm. More advanced manufacturing equipment is required if the diameter of each anti-counterfeiting unit is less than about 0.001 mm. This unfortunately can greatly increase the manufacturing cost and lower the yield, thereby rendering it difficult of being commercialized. To the contrary, the anti-counterfeiting patterns can be clearly seen in almost any angles if the diameter of each anti-counterfeiting unit is greater than about 0.001 mm (i.e., surface area of the anti-counterfeiting units being too large). It is desired that the anti-counterfeiting patterns can only be seen by varying the orientation of the invention with respect to the incident ray to a predetermined angle range. However, this can compromise the desired anti-counterfeiting function of the invention. The same applies to the anti-copy units. Distance between any two adjacent anti-counterfeiting lines (or anti-counterfeiting units) of the same anti-counterfeiting pattern is about 1 to 5 times of the diameter of the anti-counterfeiting unit. The same applies to the anti-copy sections and units. In the first preferred embodiment, the diameter of each of the first anti-counterfeiting unit 2111 and the second anti-counterfeiting unit 2211 is about 0.001 mm, the diameter of each of the first anti-copy units 2311 and the second anti-copy units 2321 is about 0.002 mm, distance between two adjacent first anti-counterfeiting units 2111 is about 0.002 mm, distance between two adjacent second anti-counterfeiting units 2211 is about 0.005 mm, distance between two adjacent first anti-counterfeiting lines 211 is about 0.003 mm, and distance between two adjacent second anti-counterfeiting lines 221 is about 0.004 mm.

Advantageously, the invention can make copy by scanning impossible. In detail, in scanning a ray of light moves from one end of the security label to the other end thereof. Both the anti-counterfeiting patterns and the anti-copy patterns are adapted to reflect light. Thus, the result of the scanning is a blurry gray image of no use. It is noted that the provision of the anti-copy patterns can make counterfeiting more difficult. The invention has the following advantages: No modules are provided in the design phase. No molds as that of laser labels are provided. For a person want to counterfeit the invention, he or she must decipher (or decode) the counterfeiting mechanism of the invention. Moreover, other factors including production temperatures, pressure values, manufacturing speed, and properties of the manufacturing materials are required to be obtained prior to production. Thus, it is very difficult of counterfeiting the invention by any unauthorized persons.

### SECOND PREFERRED EMBODIMENT

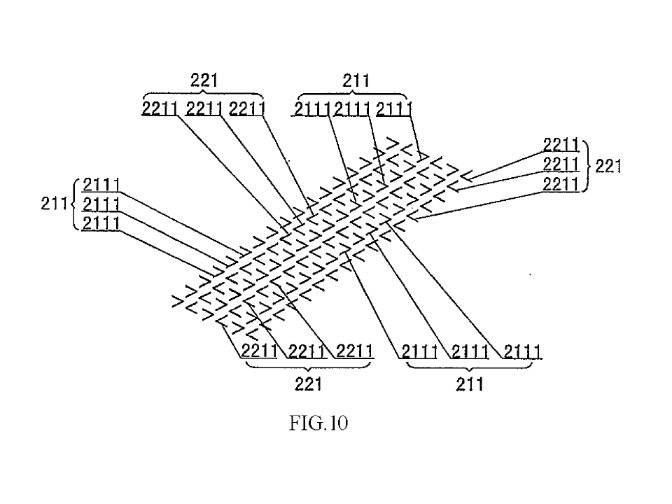

Referring to FIG. 10, overlapped area of first anti-counterfeiting pattern and second anti-counterfeiting pattern of a security label in accordance with a second preferred embodiment of the invention is shown.

The characteristics of the second preferred embodiment are substantially the same as that of the first preferred embodiment except the following: the first anti-counterfeiting lines 211 are parallel with the second anti-counterfeiting lines 221 and are alternate therewith.

The diameter of each of the first anti-counterfeiting unit 2111 and the second anti-counterfeiting unit 2211 is about 0.005 mm, the diameter of each of the first anti-copy units 2311 and the second anti-copy units 2321 is about 0.008 mm, distance between two adjacent first anti-counterfeiting units 2111 is about 0.005 mm, distance between two adjacent second anti-counterfeiting units 2211 is about 0.010 mm, distance between two adjacent first anti-counterfeiting lines 211 is about 0.015 mm, and distance between two adjacent second anti-counterfeiting lines 221 is about 0.020 mm. Alternatively, in other embodiments there are more than two parallel second anti-counterfeiting lines 221 between two adjacent, parallel first anti-counterfeiting lines 211.

### THIRD PREFERRED EMBODIMENT

The third preferred embodiment of the invention will be described below. The characteristics of the third preferred embodiment are substantially the same as that of the first preferred embodiment except the following: The diameter of each of the first anti-counterfeiting unit 2111 and the second anti-counterfeiting unit 2211 is about 0.030 mm, the diameter of each of the first anti-copy units 2311 and the second anti-copy units 2321 is about 0.040 mm, distance between two adjacent first anti-counterfeiting units 2111 is about 0.030 mm, distance between two adjacent second anti-counterfeiting units 2211 is about 0.060 mm, distance between two adjacent first anti-counterfeiting lines 211 is about 0.090 mm, and distance between two adjacent second anti-counterfeiting lines 221 is about 0.120 mm. Alternatively, in other embodiments there are more than two parallel second anti-counterfeiting lines 221 between two adjacent, parallel first anti-counterfeiting lines 211.

### FOURTH PREFERRED EMBODIMENT

The characteristics of the fourth preferred embodiment are substantially the same as that of the first preferred embodiment except the following: The diameter of each of the first anti-counterfeiting unit 2111 and the second anti-counterfeiting unit 2211 is about 0.090 mm, the diameter of each of the first anti-copy units 2311 and the second anti-copy units 2321 is about 0.088 mm, distance between two adjacent first anti-counterfeiting units 2111 is about 0.090 mm, distance between two adjacent second anti-counterfeiting units 2211 is about 0.180 mm, distance between two adjacent first anti-counterfeiting lines 211 is about 0.027 mm, and distance between two adjacent second anti-counterfeiting lines 221 is about 0.027 mm.

### FIFTH PREFERRED EMBODIMENT

The characteristics of the fifth preferred embodiment are substantially the same as that of the first preferred embodiment except the following: The diameter of each of the first anti-counterfeiting unit 2111 and the second anti-counterfeiting unit 2211 is about 0.100 mm, the diameter of each of the first anti-copy units 2311 and the second anti-copy units 2321 is about 0.095 mm, distance between two adjacent first anti-counterfeiting units 2111 is about 0.100 mm, distance between two adjacent second anti-counterfeiting units 2211 is about 0.100 mm, distance between two adjacent first anti-counterfeiting lines 211 is about 0.100 mm, and distance between two adjacent second anti-counterfeiting lines 221 is about 0.100 mm.

The invention has the following advantages:

The anti-counterfeiting patterns are formed of parallel lines. It is easy for consumers to identify the genuine products by viewing the security label placed on the product in a predetermined angle range.

The film may be printed, engraved, etc. on the substrate which may be made of one of a wide variety of materials.

No ink, dye, and organic solution are employed in the manufacturing process. This is an environmentally friendly product. Further, the manufacturing cost is decreased greatly.

More than one anti-counterfeiting pattern may be formed on the substrate without causing interference. Hence, its anti-counterfeiting effects are excellent.

Counterfeiting of the invention is very difficult.

While the invention has been described in terms of preferred embodiments, those skilled in the art will recognize that the invention can be practiced with modifications within the spirit and scope of the appended claims.

What is claimed is:

1. A security label comprising:
a substrate; and
a film formed on the substrate and comprising at least one anti-counterfeiting pattern each including a plurality of anti-counterfeiting lines each having a plurality of anti-counterfeiting units.

2. The security label of claim 1, wherein the anti-counterfeiting lines of the same anti-counterfeiting pattern are parallel straight lines and equally spaced each other, and wherein the anti-counterfeiting units are gable.

3. The security label of claim 1, wherein the anti-counterfeiting lines of the same anti-counterfeiting pattern are parallel curves and equally spaced each other, and wherein the anti-counterfeiting units are gable.

4. The security label of claim 2, wherein the at least one anti-counterfeiting pattern comprises a first anti-counterfeiting pattern and a second anti-counterfeiting pattern, and wherein the anti-counterfeiting units of the first anti-counterfeiting pattern are at angle of greater than 0-degree to less than 180-degree with respect to the anti-counterfeiting units of the second anti-counterfeiting pattern.

5. The security label of claim 4, wherein distance between any two adjacent anti-counterfeiting units of the first anti-counterfeiting pattern or the second anti-counterfeiting pattern is greater than zero, and wherein the anti-counterfeiting units of the first and second anti-counterfeiting patterns are intersected.

6. The security label of claim 5, wherein the first and the second anti-counterfeiting patterns are partially overlapped, and wherein the anti-counterfeiting lines of the first anti-counterfeiting pattern or the second anti-counterfeiting pattern are parallel.

7. The security label of claim 5, wherein the first and the second anti-counterfeiting patterns are intersected.

8. The security label of claim 4, wherein distance between any two adjacent anti-counterfeiting units of the first anti-counterfeiting pattern or the second anti-counterfeiting pattern is equal to zero, and wherein the anti-counterfeiting units of the first and second anti-counterfeiting patterns are not intersected.

9. The security label of claim 8, wherein the first and the second anti-counterfeiting patterns are partially overlapped, and wherein the anti-counterfeiting lines of the first anti-counterfeiting pattern or the second anti-counterfeiting pattern are parallel.

10. The security label of claim 8, wherein the first and the second anti-counterfeiting patterns are intersected.

11. The security label of claim 2, wherein distance between any two adjacent anti-counterfeiting units of the first or second anti-counterfeiting pattern is about 1 to 5 times of diameter of the anti-counterfeiting unit of the first or second anti-counterfeiting pattern, and wherein distance between any two adjacent anti-counterfeiting lines of the first or second anti-counterfeiting pattern is about 1 to 5 times of diameter of the anti-counterfeiting line of the first or second anti-counterfeiting pattern.

12. The security label of claim 1, further comprising a plurality of anti-copy patterns formed on an area on top of the substrate not occupied by the film.

13. The security label of claim 12, wherein the anti-copy pattern comprises at least one anti-copy section each including a plurality of equally spaced anti-copy units.

14. The security label of claim 13, wherein the anti-copy units are gable.

15. The security label of claim 14, wherein the anti-copy units are at angle of greater than 0-degree to less than 180-degree with respect to the first anti-counterfeiting units.

16. The security label of claim 15, wherein the anti-counterfeiting units are fixedly formed on top of the substrate.

17. The security label of claim 15, wherein the anti-counterfeiting units are formed integrally with top of the substrate.

18. The security label of claim 15, wherein the anti-copy units are fixedly formed on top of the substrate.

19. The security label of claim 15, wherein the anti-copy units are formed integrally with top of the substrate.

20. The security label of claim 16, wherein diameter of the anti-counterfeiting unit or the anti-copy unit is between about 0.001 to 0.1 mm.

21. The security label of claim 20, wherein diameter of the anti-counterfeiting unit or the anti-copy unit is between about 0.005 to 0.090 mm.

22. The security label of claim 20, wherein distance between any two adjacent anti-counterfeiting units of the first or second anti-counterfeiting pattern is about 1 to 5 times of diameter of the anti-counterfeiting unit of the first or second anti-counterfeiting pattern, and wherein distance between any two adjacent anti-counterfeiting lines of the first or second anti-counterfeiting pattern is about 1 to 5 times of diameter of the anti-counterfeiting line of the first or second anti-counterfeiting pattern.
